(19) United States
(12) Patent Application Publication
(10) Pub. No.: US 2006/0248148 A1
(43) Pub. Date: Nov. 2, 2006

(54) Technique for providing a personalized electronic messaging service through an information assistance provider

(76) Inventors: Timothy A. Timmins, Beaverton, OR (US); John S. Miller, Canby, OR (US); P. Bryan Dooling III, Tigard, OR (US)

Correspondence Address: ALEX L. YIP;c/o Kaye Scholer LLP, 425 Park Avenue, New York, NY, 10022, US

(21) Appl. No.: 11/116,702

(22) Filed: Apr. 28, 2005

(51) Int. Cl. G06F 15/16

(52) U.S. Cl. 709/206

(57) ABSTRACT

To provide a personalized voice email service, data pertaining to one or more of a user's email accounts, e.g., email addresses and account access data, is maintained in a folder by an information assistance service, which is unaffiliated with the email service providers (e.g., AOL, Hotmail, etc.) maintaining the user's email accounts. When the user calls the information assistance service, the user's folder is retrieved. The user's email accounts may be accessed on behalf of the user based on the email addresses and account access data in the user's folder. An information assistance provider including, e.g., an operator and/or a voice server, may present information concerning the email messages received in the user's email accounts in different manners. For example, header information (e.g., sender/address, subject, etc.) concerning the selected email messages may be announced to the user. The operator may use a stored name of the sender of an email message when announcing header information. At the user's request, a message may be sent to the user whenever an email message is received from a specified individual or email address.

### FIELD OF THE INVENTION

The invention relates to a communications system and method, and more particularly to a system and method for enabling a user of an information assistance service to access electronic messaging services including, e.g., email services.

### BACKGROUND OF THE INVENTION

In this information age, people need to be well informed and organized to effectively carry out day-to-day activities, especially when they are traveling and away from their “home” base where they normally conduct their business. As a result, use of mobile devices which facilitate mobile communications, such as wireless telephones, is ubiquitous.

Wireless phones conveniently allow users while traveling to call and communicate with other people. In case a user cannot remember the telephone number of a contact or it is not handy, or the user wants to obtain directions and other information concerning, e.g., restaurants, theaters, etc., he or she can call an information assistance provider for assistance which includes, e.g., an operator, a voice server, etc. To that end, an expansive network of communication call centers has been established which provides users with nationwide assistance.

Email messaging has in recent years become a widespread tool used for communicating. Many individuals maintain email accounts with different email service providers (ESPs), e.g., America Online (AOL), Hotmail, etc. However, a shortcoming of common telephones, including wireless phones, is their inability to access email messages in such accounts.

### SUMMARY OF THE INVENTION

The invention enables a user to communicate with (e.g., by calling) an information assistance provider to receive information concerning email messages received in the user's email accounts, which are furnished by providers unaffiliated with the information assistance provider. Data concerning access to one or more email accounts associated with a user is stored at the information assistance service. When a communication from the user is received through a first communications connection, the data is retrieved and used to access the one or more email accounts over a second communications connection. One or more operations are performed with respect to one or more email messages received in the one or more email accounts on behalf of the user. Information concerning at least one email message in the one or more email accounts is provided to the user. For example, a list of email messages that satisfy one or more predetermined criteria may be reported to the user. New email messages, e.g., email messages received since the last time the user called the information assistance service, may be reported.

Header information (e.g., sender name/address, subject, etc.) may be provided to the user for selected email messages. At the user's request, a selected email message may be opened and read to the user. The user may then, if he/she wishes, send a reply email message. In connection with generating a reply email message, the user may be prompted to state a voice message, which is converted into an audio file and attached to the reply email message. The reply email message is then sent to a recipient. In addition, the email message may be forwarded to a specified recipient at the request of the user. In accordance with an aspect of the invention, if requested, a user may be notified if a delivery error message is received in connection with a reply email or forwarded email.

In accordance with another aspect of the invention, a user may request that he/she be notified whenever an email message is received from a specified individual or email address. If such a message is detected, an alert message is sent to an address specified by the user. An alert message may be transmitted by email, telephone, facsimile, text message, etc. In one embodiment, the user may be charged to receive alert messages. Alert messages may also be provided to notify a user of other types of information that may interest him or her. Alert messages may be generated and sent based on information in a user's personal profile. For example, an alert message may be sent to a user to notify him/her of an upcoming event, e.g., a musical event, matching a preference specified in his/her profile.

In accordance with yet another aspect of the invention, an information assistance service stores first data concerning access to one or more email accounts associated with a user. In addition, a contacts folder associated with the user is stored. The contacts folder contains first information concerning one or more contacts. The first information includes names by which the user refers to the respective contacts. When a communication is received from the user through a first communications connection, the first data is retrieved. Based on the first data, the one or more email accounts are accessed over a second communications connection. Second data is obtained which concerns a sender of a selected email message received in one of the email accounts. A name of a contact in the contacts folder is identified based on the second data. The user is then provided with second information concerning the selected email message. The second information includes the name of the contact. In an embodiment in accordance with this aspect of the invention, an operator uses a stored name of the sender of an email message when announcing header information to a user. A sender's name may be retrieved, for example, from a contacts folder maintained for the user.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 illustrates a communications system including information/call centers, in accordance with the invention;

FIGS. 2A and 2B are block diagrams of components of the communications system of FIG. 1;

FIG. 3 is a block diagram of an electronic messaging gateway in the communications system of FIG. 1;

FIG. 4 is a flowchart depicting a routine for eliciting from a user information concerning one or more email accounts;

FIG. 5 illustrates a record maintained in a user's email folder;

FIG. 6 illustrates a Login graphical user interface (GUI) for providing personalized information and communications services;

FIG. 7 is a flowchart depicting a routine for providing information concerning statuses of a user's email accounts;

FIGS. 8A-8C respectively illustrate lists of email messages received in various email accounts maintained by a user;

FIG. 9 illustrates a GUI containing information concerning email messages in a user's email accounts;

FIG. 10 illustrates a list of message IDs for selected email messages;

FIG. 11 is a flowchart depicting a routine for providing information concerning newly arrived email messages;

FIG. 12 is a flowchart depicting a routine for opening and reading an email message;

FIG. 13 is a flowchart depicting a routine for deleting an email message;

FIG. 14 depicts a routine for creating and sending a reply email message;

FIG. 15A illustrates an example of a reply email form;

FIG. 15B illustrates an example of a forward email form;

FIG. 16 is a flowchart depicting a routine for detecting a delivery error and notifying a user thereof, in accordance with the invention;

FIGS. 17A-17D respectively illustrate a set of tables in the user's email folder to facilitate message filtering functions;

FIGS. 18A-18B respectively illustrate a filter option table and a time parameters table resulting from setting up a time range message filter;

FIG. 19 is a flowchart depicting a routine for screening email messages using the time range message filter;

FIG. 20 illustrates a GUI containing information concerning the email messages resulting from the screening using the time range message filter;

FIG. 21 illustrates a GUI containing information concerning email messages received from a sender's address selected using a message address filter;

FIG. 22 is a flowchart depicting a routine for notifying a user that an email message has arrived from a specified address, in accordance with the invention;

FIG. 23 is illustrates a contacts record, in accordance with the invention;

FIG. 24 is a flowchart depicting a routine for using stored name data to announce header information to a user, in accordance with the invention; and

FIG. 25 illustrates a GUI containing information concerning selected email messages, in which stored name data is used to present header information, in accordance with the invention.

### DETAILED DESCRIPTION

The invention is directed to providing personalized information and communications services to users, e.g., telephone and mobile device users. One of these services is a personalized voice email service in accordance with the invention, which allows a user to, among others, access email in one or more email accounts via voice media.

To facilitate tailoring an information assistance service to individuals' needs, one or more folders are maintained for a user, based on which the service is rendered to the user. For example, as disclosed in copending, commonly assigned U.S. application Ser. No. 09/865,230, filed on May 25, 2001 (“the '230 Application”), incorporated herein by reference, contacts folders and appointments folders may be created and maintained to store a user's contacts and appointments information, respectively. In addition, in accordance with an aspect of the invention, an email folder may be created and maintained to store a user's email information, e.g., data pertaining to one or more email accounts that the user wishes to access via the information assistance service. Such email accounts were previously established by the user with such email service providers (ESPs) as AOL, Hotmail, etc., which are-unaffiliated with the present information assistance service provider. With the email folder in place, when the user accesses, e.g., by calling, the information assistance service, the user may be informed of any newly arrived email messages in his/her various email accounts, may be able to learn the content of an email message and reply thereto, and may take advantage of other related services offered by the information assistance provider, as will be fully described below.

Like a contacts or appointments folder, an email folder for a user may be maintained by the information assistance service in association with an identifier of the user, e.g., the user's telephone number. Thus, in this particular illustrative embodiment, when an information assistance call is received, the subject service locates the folders associated with the caller based on an automatic number identification (ANI) associated with the call. As is well known, the ANI identifies the telephone number of the communications device from which the call originates. However, it should be noted that a user identification (ID), password, PIN, mother's maiden name, user voiceprint, etc. may be used in combination with, or in lieu of, an ANI to identify a user. For example, use of a voiceprint to identify a user is disclosed in copending, commonly assigned U.S. application Ser. No. 10/403,207 filed on Mar. 31, 2003, incorporated herein by reference.

A user profile may also be maintained containing preferences of a user associated therewith, as described in co-pending, commonly assigned U.S. application Ser. No. 10/323,287, filed on Dec. 19, 2002 (“the '287 application”), incorporated herein by reference. A user may specify in a user profile his/her preferred types of events, areas of interest, food, goods, services, manufacturers, merchants and other personal preferences, e.g., preferred music, fashion, sports, restaurants, seating on a plane, frequent flyer number, frequent stay number, sizes of jackets, etc. Such a profile may be used by a server to tailor the content of information delivered automatically to the user as soon as the information becomes available. The user may also specify in the profile the preferred method of handling his/her information assistance call, e.g., use of a special skilled operator, such as a Spanish speaking operator, to answer such a call. Thus, by using a user profile, the user is automatically provided with an individualized service, without the need of otherwise repeating the preferences each time when calling an operator to obtain information and assistance. The personal preferences in a user profile may be specified by a user during registration with the information assistance service via a phone call, for example, in response to registration questions posed by an operator or voice server 230. Personal preferences may also be entered and changed via a web page.

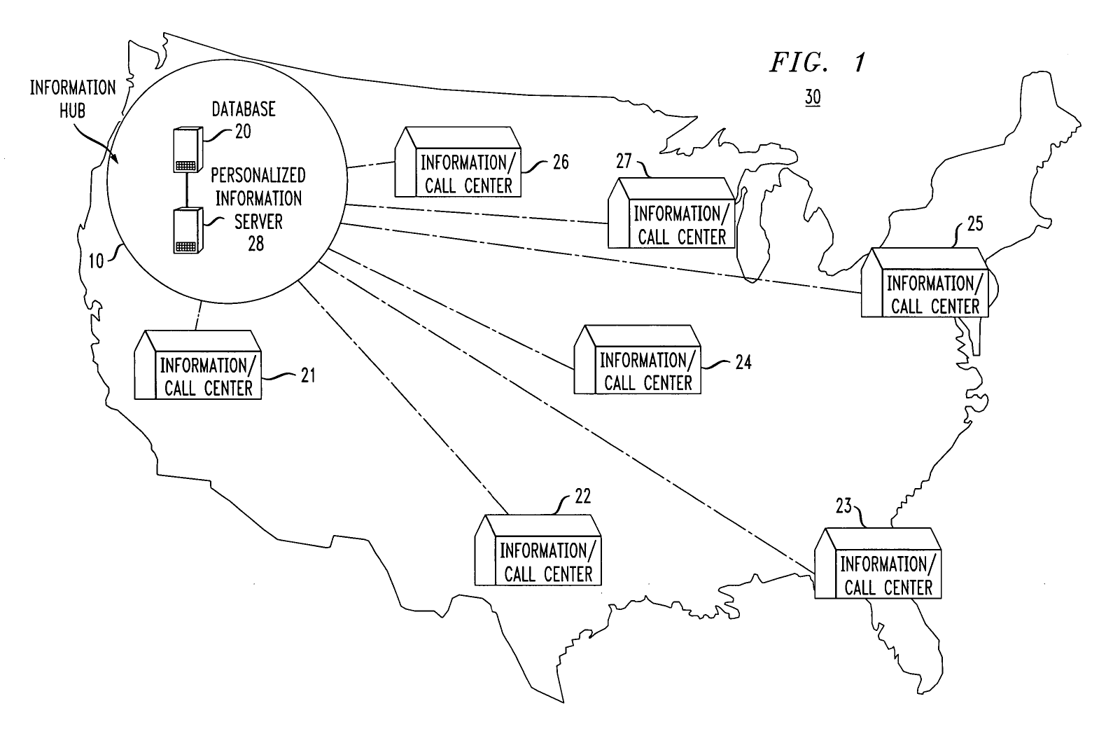

FIG. 1 illustrates a communications system for providing, inter alia, a personalized voice email service in accordance with the invention. This communication system includes wide area network (WAN) 30 covering an extensive area. WAN 30 may be an Internet-based network such as the World Wide Web or a private intranet based network. WAN 30 connects operators dispersed throughout a wide coverage area in information/call centers 21 through 27. It should be noted that the term “operators” used herein broadly encompasses entities that are capable of providing assistance in a telecommunications environment, including without limitation human operators, voice response/recognition capabilities, web-/WAP-enabled operator services, and other automated and electronic access. One or more information hubs 10 are also included in WAN 30. An information hub 10 includes one or more personalized information servers 28 which are accessible by the operators in the system, and one or more databases 20 in which users' email, contacts, appointments and other folders may be stored and maintained. Such folders may also be stored locally at one or more of the information/call centers. The folders and information at different centers are synchronized. Synchronized databases provide necessary backup as well as support to roaming mobile device users.

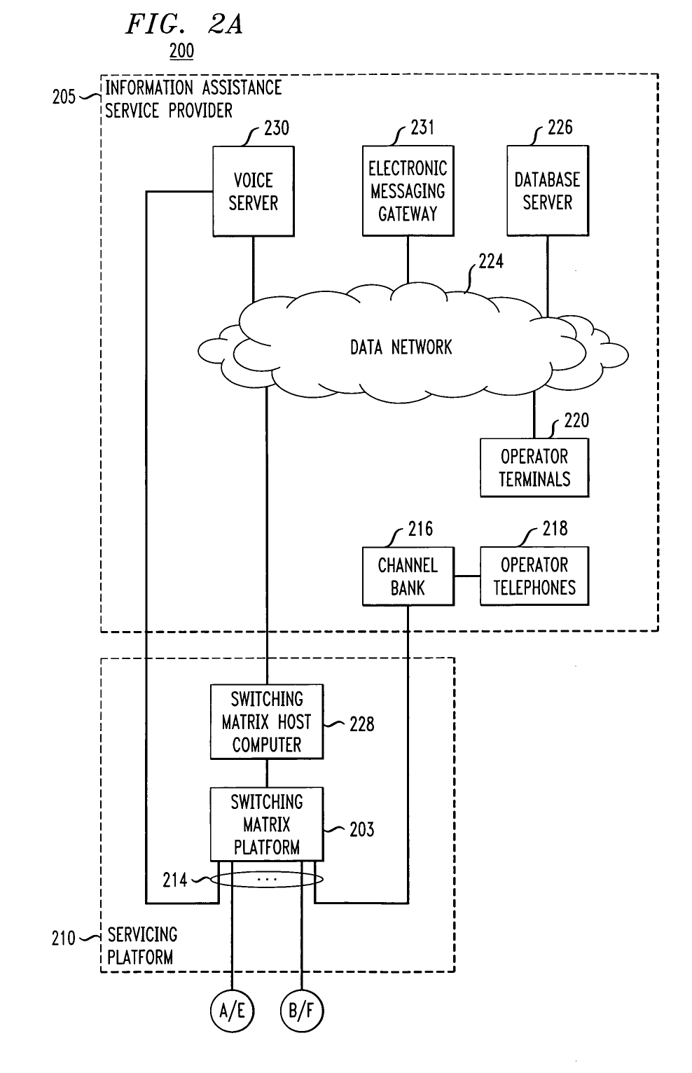

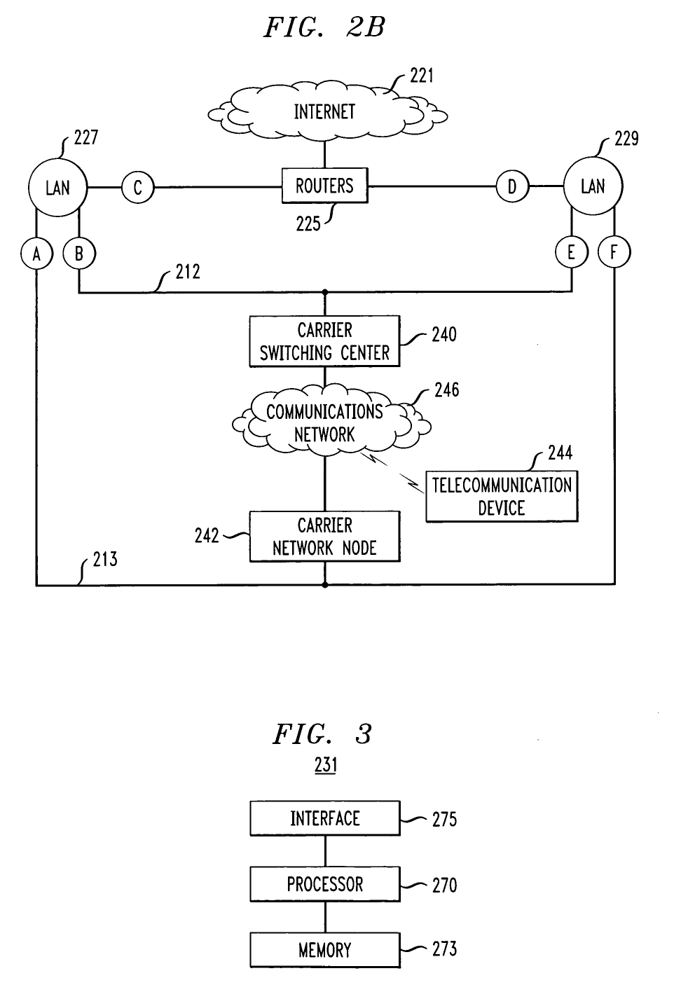

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 226 provides access to, among others, directory information from multiple sources. Database server 226 enables the operator to search directory information not just by name and address (sometimes city or area code) of a desired party, but also by type of goods/services and/or geographical region of a desired entity.

Data network 224 further connects to voice server 230, electronic messaging gateway 231, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand-placed on center 200 and platform 203 for each corresponding function.

Voice server 230 is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto. Voice server 230 is employed to play the constantly repeated parts of an operator's speech, including, for example, the caller's desired telephone number where requested, and possibly other information. At appropriate stages in a call progression, switch matrix host computer 228 initiates a voice path connection between voice server 30 and switching matrix platform 203 such that the user, or the user and the operator, are able to hear whatever pre-recorded speech is played on that connection by voice server 230. Computer 228 then instructs voice server-230, via data network 224, what type of message to play, and passes data parameters that enable voice server 230 to locate the message appropriate to the call state.

FIG. 3 illustrates electronic messaging gateway 231, which includes processor 270, memory 273 and interface 275. Instructed by software stored in memory 273, processor 270 is configured for communicating with email servers through interface 275, which may be, e.g., POP3 (Post Office Protocol Version 3) or IMAP (Internet Message Access Protocol) compliant email servers. Interface 275 provides processor 270 with access to data network 224 and thence to Internet 221. For example, in response to signals from terminal 220, processor 270 may initiate Internet access and communicate with email servers operated by such ESPs as AOL, Hotmail, etc. Processor 270.causes one or more email messages in a user's specified email accounts to be downloaded from the email servers, or alternatively may obtain data describing the email messages without downloading the actual email messages. Selected portions of the messages or data may be transmitted to terminal 220 for presentation to a human operator who in turn conveys the same to the user, or to voice server 230 which communicates the same to the user in automated voice.

Users of a particular telephone carrier may dial, speak or otherwise communicate predetermined access digits, access codes or retail numbers, or input a predetermined address or a Uniform Resource Locator (URL) established for information assistance by that company. The instant example assumes that the user dials, e.g., “411,” “*555,” “555-1212,” “1-800-555-1212,” “00,” or other designated access numbers. The participating telephone company's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes may be utilized, such as skills-based routing based on, e.g., a preferred call handling method specified by a user profile, or a priority scheme for preferred callers. The queue is maintained by switching matrix host computer 228.

To subscribe to the personalized voice email service, the user may call an operator at the designated access number. As part of the registration, the operator enters at a user data web page on server 28 user identifying information including username, password, and telephone number of the particular telecommunications device, e.g., a wireless telephone in this instance, which the user would use to call the information assistance service in the future. It is particularly advantageous to use such a phone number (also known as a mobile directory number (MDN) in the case of a wireless phone number) to identify the user since, as described before, the calling number would be automatically captured as an ANT at information/call center 200 when the user calls. Specifically, platform 214 in center 200 in a well-known manner derives the ANT from the call set-up signals associated with the user's call.

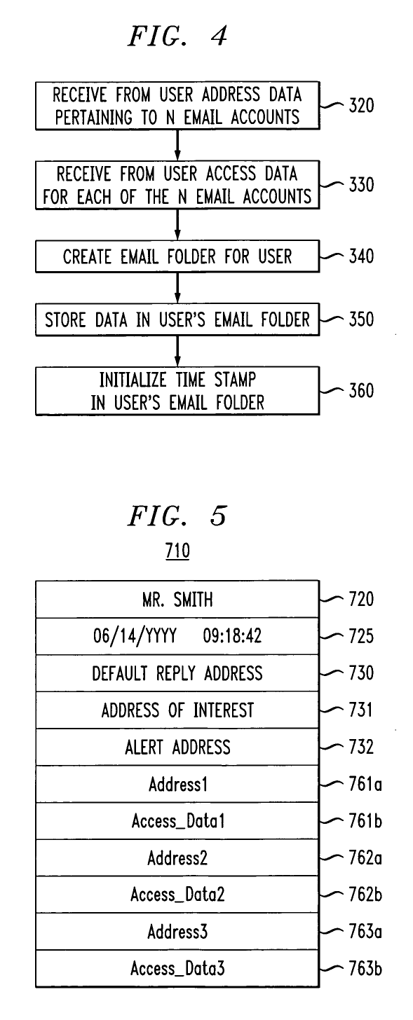

During the registration, the operator may also ask the user which email accounts he/she wishes to have associated with the personalized voice email service. The user responds by identifying, say, N, email accounts, where N is an integer greater than or equal to one. Thus, as part of the registration, email address information pertaining to the user's N email accounts is received from the user, as indicated at step 320 in FIG. 4. For example, the user may provide such email addresses as smith@aol.com, smith@hotmail.com, etc. It may be necessary to prompt the user to provide sufficiently detailed information to enable electronic messaging gateway 231 to access the specified email accounts. For example, at step 330, the operator elicits and receives from the user access data for each of the N email accounts. Access data may include, e.g., a username, password, etc., associated with each email account. At step 340, an email folder is created for the user in database 20. As mentioned before, such an email folder may be stored in databases 20, in association with the user's identification data (such as an ANT) for the user's access to his/her email accounts. At step 350, the user's name (and other identifying information, if any), the email account addresses, and the email account access data are stored in a record in the user's email folder.

FIG. 5 illustrates one such record 710 that may be maintained in an email folder of a hypothetical user named Mr. Smith. Record 710 comprises fields 720, 725, 730-732, 761a-b, 762a-b and 763a-b. In this example, field 720 contains Mr. Smith's name. Field 725 contains a time stamp representing a date and time at which Mr. Smith most recently called the information assistance service and accessed the personalized voice email service. Fields 761a and 761b respectively contain the email address (Address1) of Mr. Smith's first email account and access data (Access_Data1) therefor provided by Mr. Smith. Fields 762a and 762b respectively contain the email address (Address2) of Mr. Smith's second email account and access data (Access_Data2) therefor provided by Mr. Smith. Fields 763a and 763b respectively contain the email address (Address3) of Mr. Smith's third email account and access data (Access_Data3) therefor provided by Mr. Smith. It should be noted that although in this example, data for three email accounts is maintained in record 710, in alternative embodiments data for any number of email accounts may be maintained.

Returning briefly to FIG. 4, at step 360, the time stamp in field 725 of record 710 is initialized with the current time for future reference. Subsequently, the time stamp is updated every time the user checks his/her email through the personalized voice email service.

The operator may also ask the user if he/she wishes to specify a default reply address for recipients of the user's email messages to reply thereto. If the user specifies a default reply address, e.g., one of Address1, Address2 and Address3 in the Mr. Smith case, the default reply address is registered in field 730 of record 710.

The user may additionally wish to be notified if an email message from a particular “address of interest” arrives in one of his/her email accounts. If the user specifies such information, the address of interest is recorded in field 731. The user may additionally specify an address to which any such notification is to be sent, and may specify under what conditions notices may be delivered. For example, an “alert address,” specifying the email address to which notices are to be sent, is stored in field 732. A user's alert address may encompass other forms of communications, as well. For example, a user may specify in field 732 a telephone number, a facsimile number, a pager number, etc.

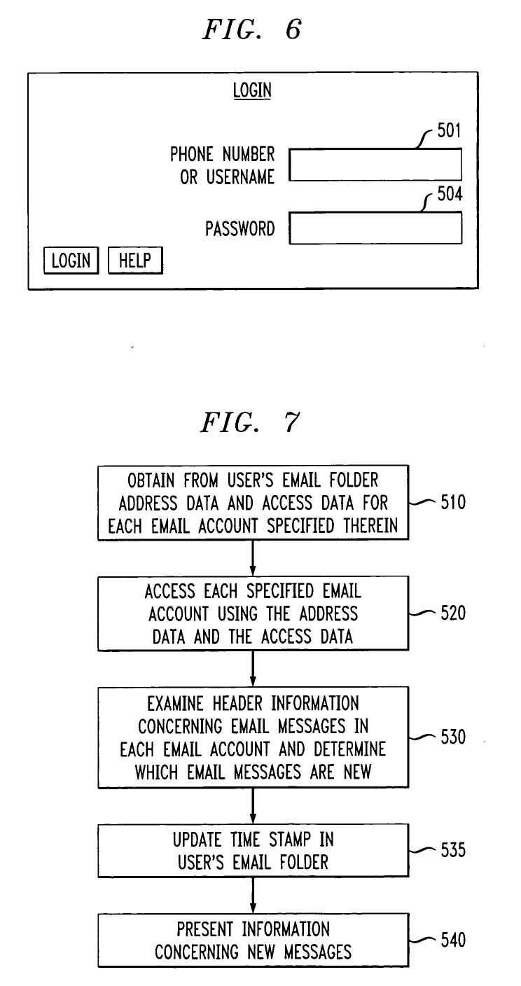

The user may subsequently use telecommunications device 244, e.g., a wireless phone, to call the information assistance service. Let's say the call is routed to information assistance/call center 200 where an operator attends to the call. After the user communicates his/her needs, e.g., to access the personalized voice email service, the operator at terminal 220 establishes communications with personalized information server 208 through WAN 30 (or alternatively Internet 221). In response, server 28 presents on terminal 220 a Login graphical user interface (GUI), which is illustrated in FIG. 6. As shown in FIG. 6, the operator is prompted to enter the user's phone number or username to identify the user, and a password to verify that the user is authorized to access the information assistance service.

The ANI received from his/her communication device may be automatically provided in entry 501 of the Login GUT by server 28, thereby obviating the need of the operator's eliciting from the user, and entering, the required phone number or username. (In the event that such an ANI is not automatically available, or where the user is accessing the subject service from an unknown point or the operator suspects that the user calls from a phone number other than the registered phone number, the operator may verify/obtain the necessary identifying information with/from the user.) At entry 504, the operator enters the password provided by the user to complete the login process. The login information is then transmitted to server 28, where it checks the aforementioned user data web page to verify the received ANT and password. After they are verified, server 28 identifies the user's email folder based on the ANT. A copy of the user's email folder is provided to electronic messaging gateway 231.

Let's suppose, for example, that Mr. Smith calls the information assistance service, and after his authorization is established, he asks the operator to tell him how many new email messages are in his email accounts. The operator may select a predetermined option on the screen of terminal 220, and in response, gateway 231 uses the information in Mr. Smith's email folder, and in particular record 710 therein, to access his email accounts. FIG. 7 is a flowchart depicting a routine for providing information pertaining to a user's email accounts, in accordance with one embodiment. At step 5 10, gateway 231 obtains from record 71 0 the address data for each email account listed therein and the access data for each such account. In the illustrative example, gateway 231 examines fields 761-763 and retrieves the addresses and access data for Mr. Smith's email accounts with three different FSPs. At step 520, gateway 231 accesses each of the specified email accounts using the address and access data. Gateway 231 may communicate, via Internet 221, with the corresponding email servers at their respective URLs pursuant to a standard protocol such as IMAP or POP3. In particular, IMAP allows a client to access and manipulate email messages on the server. For example, IMAP allows a client to obtain the header information, e.g., the email sender name and/or origination address, subject of the email, email receipt time, etc., apart from the body of the email message. IMAP also permits manipulation of remote “mailboxes,” in a way that is functionally equivalent to local mailboxes. IMAP further allows for creating, deleting, and renaming mailboxes; checking for new messages; permanently removing messages; setting and clearing flags, and other functions including parsing and searching. In accordance with IMAP, each email message stored on an email server is given a unique email message identifier (message ID). When a client inquires about or retrieves an email message from a server, the client can retrieve the associated message ID as well.

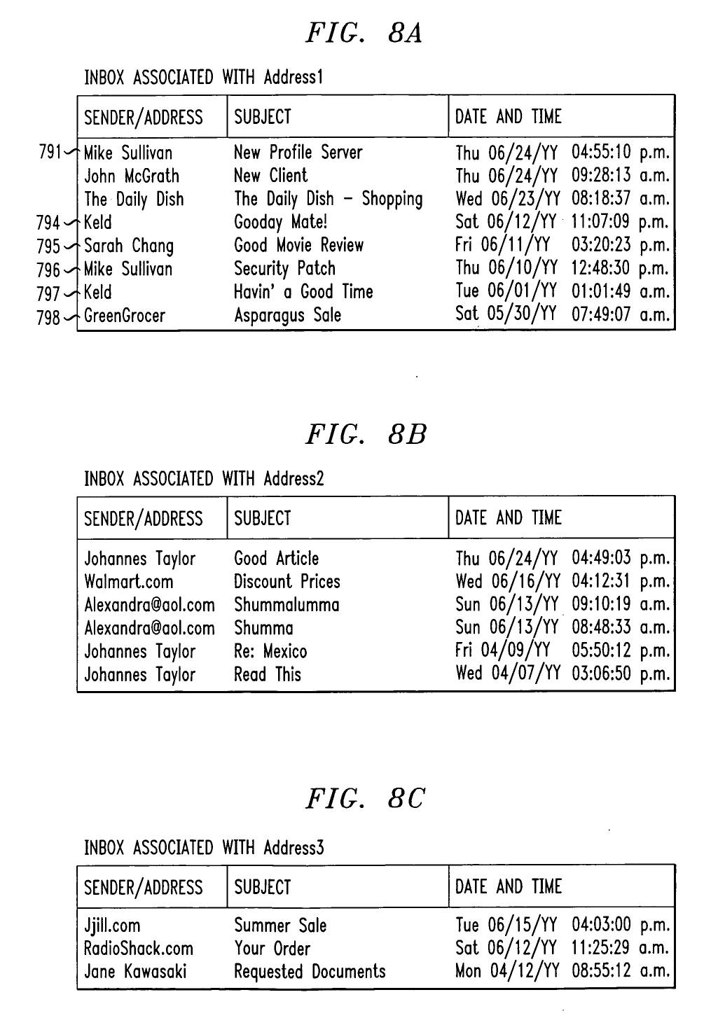

After accessing Mr. Smith's email accounts, gateway 231 examines header information for the emails in each account. By way of example, gateway 231 may access Mr. Smith's email accounts at Address1, Address2 and Address3, and determine contents of inboxes of the accounts, illustrated in FIGS. 8A-8C, respectively. FIG. 8A illustrates the content of the inbox associated with Address1, which includes such header information as the name of the sender (if provided, otherwise the sender's email address), subject information, and a receipt time stamp for each of eight email messages received in Mr. Smith's email account at Address1. For example, referring to entry 791, an email was received from Mike Sullivan concerning the subject “New Profile Server” on Thursday, Jun. 24, YYYY, at 4:55:10 p.m. FIG. 8B illustrates similar information for Mr. Smith's email inbox associated with Address2; FIG. 8C illustrates similar information for his email inbox associated with Address3.

Returning to FIG. 7, at step 530, gateway 231 examines the header information concerning the email messages in each email account and determines which email messages are new. To determine which email messages are new, gateway 231 examines the receipt time stamp associated with each email message and designates as “new” any email message that was received after the date and time specified in field 725 of record 710. For example, referring again to entry 791 in FIG. 8A, the email message from Mike Sullivan was received on Jun. 24, YYYY at 4:55:10 p.m., which is after the Jun. 14, YYYY, 09:18:42 time stamp in field 725 of record 710 in Mr. Smith's email folder; accordingly, the email message from Mike Sullivan is designated as a new email message. On the other hand, referring to entry 798, the email message from GreenGrocer concerning “Asparagus Sale” was received on Saturday, May 30, YYYY at 7:49:07 a.m., which is before the June 14, YYYY, 09:18:42 time stamp in Mr. Smith's email folder; accordingly, the GreenGrocer email is not new. It should be noted that in an alternative embodiment, a user may configure message filter parameters in his/her email folder to redefine the test for “new” email messages. This function is discussed in more detail below.

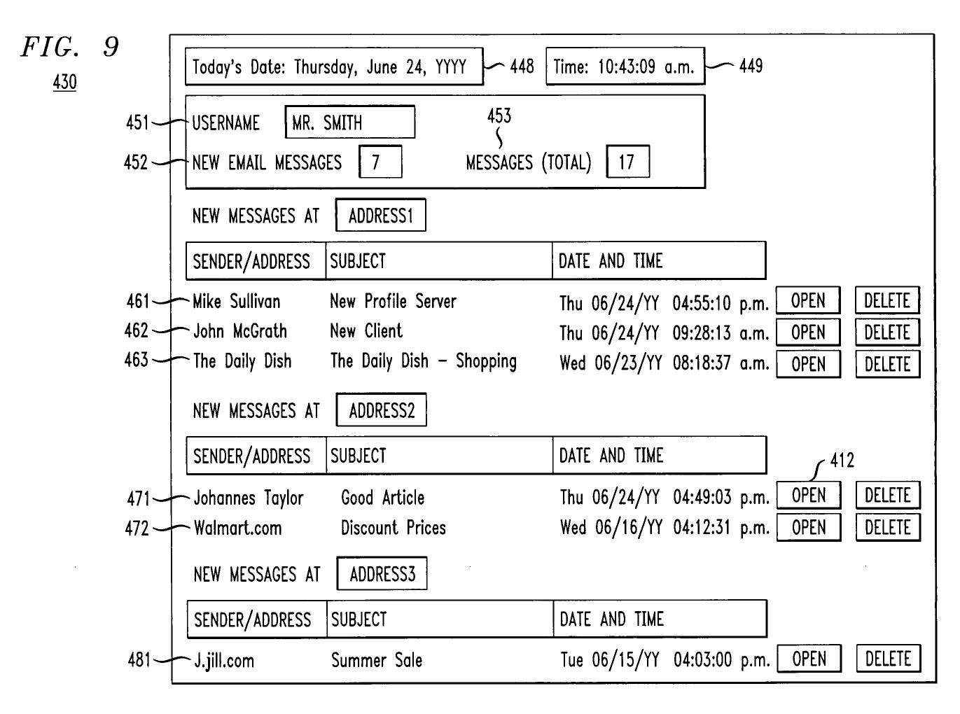

At step 535, gateway 231 updates the time stamp in field 725 of record 710 to indicate that the Mr. Smith has checked his email. In this example, gateway 231 updates field 725 with the current date and time. At step 540, gateway 231 presents to the operator on terminal 220 a GUI, such as that shown in FIG. 9, containing information concerning the new email messages in Mr. Smith's email accounts.

GUI 430 in FIG. 9 displays summary data including, e.g., Mr. Smith's name at username entry 451, the number of new email messages in the user's email accounts (452) the total number of messages in the user's email accounts (453), and the current date (448) and time (449). Below the summary data, GUI 430 displays header information for each new email message present in the user's email accounts. For example, referring to entries 461-463, three new email messages are present in Mr. Smith's first email account at Address1. Similarly, two new email messages (entries 471-472) are present in Mr. Smith's second email account at Address2, and one new email message (entry 481) is present in Mr. Smith's account at Address3. In this example, GUI 430 displays, for each new email message, header information including the sender's name and/or email address, a subject line description, and the date and time the email message was received.

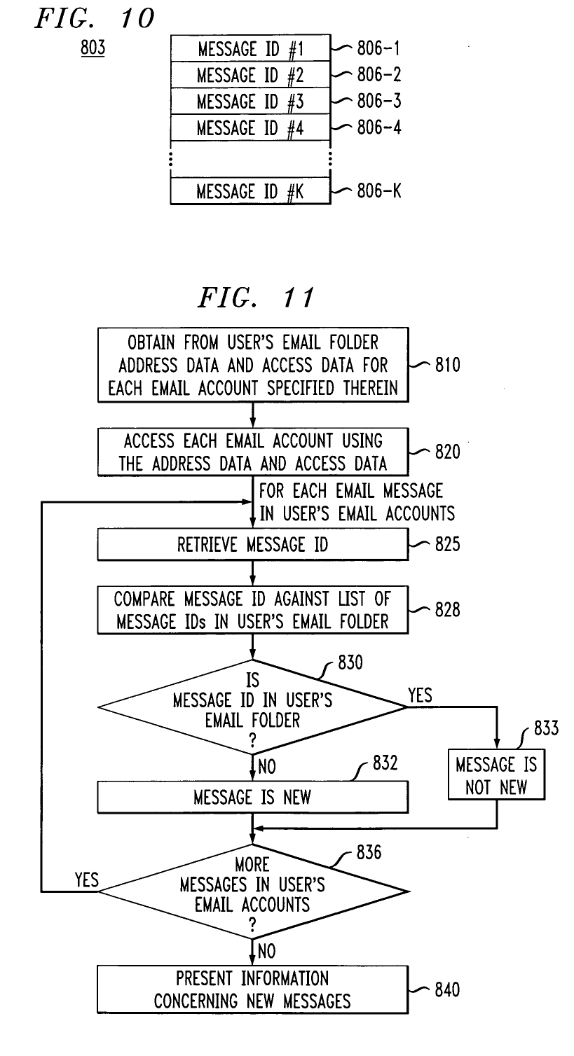

In an alternative embodiment, gateway 231 determines whether or not an email message in an email account is new based on its message ID. In this embodiment, a list of message IDs is maintained in the user's email folder. The list holds message IDs of email messages that have been opened and read to the user. Accordingly, each time an information assistance provider opens and reads an email to the user, the message ID of the respective email is added to the message ID list in the user's email folder. FIG. 10 illustrates one such message ID list (denoted 803), which comprises K message ID entries 806-1 through 806-K, where K represents an integer. In one embodiment, message IDs are deleted from list 803 a predetermined period of time after being added.

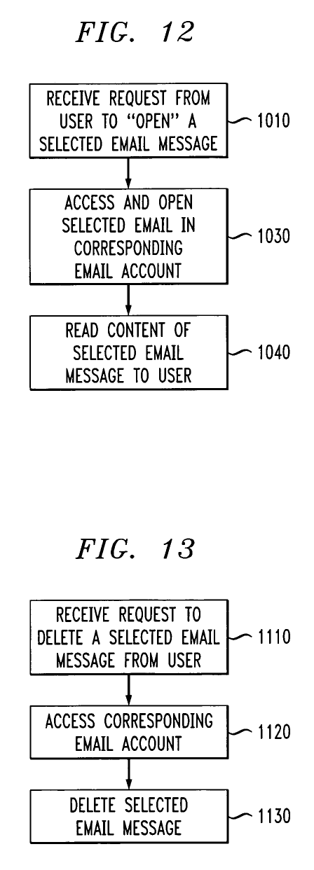

FIG. 11 illustrates a routine for providing information pertaining to a user's email accounts, in accordance with the alternative embodiment. Steps 810 and 820 are identical to steps 510 and 520 in the routine of FIG. 7. Thus, gateway 231 obtains address data and access data from the user's email folder (step 810), and accesses each specified email account (step 820). For each email message in the user's email accounts, gateway 231 retrieves its message ID (step 825), and compares the message ID against the entries of list 803 (step 828). As indicated at block 830, if the message ID is not currently in list 803 (i.e., in the user's email folder), the email message is new (block 832). If the message ID is currently in list 803, the email message is not new (block 833). As indicated by block 836, after all the email messages in the user's accounts are examined, gateway 231 presents information concerning the new email messages on terminal 220 at step 840. It should be noted that other methods for identifying email messages (e.g., by sender's name and time of receipt) may be similarly used to determine whether or not a message is new.

Returning to FIG. 9, upon viewing GUI 430, an operator may inform Mr. Smith of the statuses of his email accounts. For example, the operator may state, “Mr. Smith, you have seven new messages in your email inboxes.” The operator's status message may be varied. For example, the operator may alternatively state, “Three messages have arrived today. There are seventeen messages in your inboxes.” The particular style of presentation of the email account statuses may be specified during the service registration, and recorded in the user's email folder for future reference.

The user's email account status information may alternatively be conveyed by voice server 230 to the user in automated voice. The user may also be provided with a menu of selectable options including “Read Headers,” “Open,” “Next,” “Previous,” “Delete,” “Menu,” “Forward,” “Reply,” “Repeat,” and “Operator.”

For example, when the “Read Headers” option is selected, e.g., by saying “Read Headers” or pressing a predetermined key on the telephone, gateway 231 initiates a “Read Headers” routine, causing voice server 230 to begin reading the header information for the new email messages. This may be done without prompting or an explicit selection of an option by the user. Thus, referring to FIG. 9, voice server 230 may automatically read the header information for the message from Mike Sullivan, then read the header information for the message from John McGrath, etc. For example, voice server 230 may announce:
“Received today from Mike Sullivan, subject New Profile Server,”
“Received today from John McGrath, subject New Client,”
“Received on Jun. 23, YYYY from The Daily Dish, subject The Daily Dish—Shopping,”
“Received today from Johannes Taylor, subject Good Article,” etc.

Voice server 230 may also read the addresses listed in the ‘To:’ field and/or the addresses listed in the ‘cc:’ field of each email message. Additionally, voice server 230 may inform the caller of the existence of any attached files in an email message. In an alternative embodiment, the operator may read the header information and other information in response to a request by the user.

It should be noted that at any time during a user's interaction with voice server 230, the user may state “Menu” (or, alternatively, press a predetermined key on his/her telephone) to cause a list of currently available options to be played. For example, if Mr. Smith says “Menu” at any time during the “Read Headers” routine, the “Read Headers” routine stops and voice server 230 reads a menu of options, such as “Read Headers,” “Open,” “Next,” “Previous,” “Delete,” “Menu,” “Forward,” “Reply,” “Repeat,” and “Operator.”

Continuing with the above example, while the header information is being read, Mr. Smith may request that a particular email message be opened and read. For example, after voice server 230 reads the header information for the email message from Johannes Taylor, Mr. Smith may say “Open” (or press a predetermined key on his telephone). FIG. 12 illustrates a routine for opening and reading an email message in response to Mr. Smith's request, in accordance with an embodiment. At step 1010, voice server 230 receives a request to open a selected email message from Mr. Smith when he says “Open”. In response, voice server 230 signals Gateway 231 to access and open the selected email message (step 1030). Alternatively, on hearing Mr. Smith's request, the operator attending to the call may select the email message in-question, e.g., by selecting on the “Open” option 412 to the right of the Johannes Taylor message header information. After the email message is opened, voice server 230 at step 1040 reads the content of the email to Mr. Smith by means of a conventional text-to-voice conversion application. In the alternative embodiment described above, after an email message is opened and read, its message ID is added to list 803 in the user's email folder.

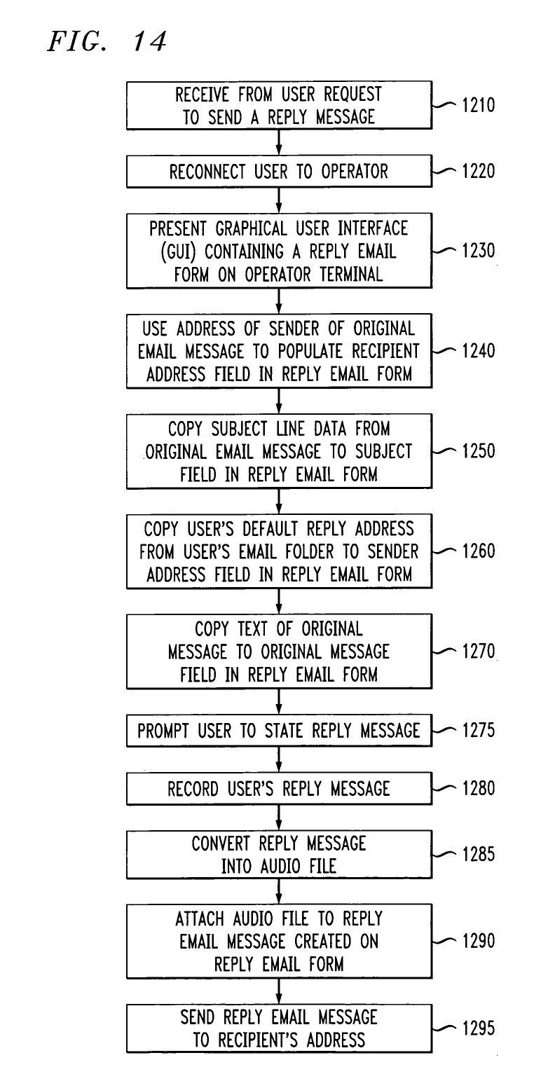

While a email message is being read or after it has been read by voice server 230, a user is provided with multiple options. For example, the user may wish to delete the message. FIG. 13 is a flowchart depicting a routine for deleting an email message in response to a user's request. Suppose that after hearing the email message from Johannes Taylor, Mr. Smith wishes to delete it. Accordingly, he may say “Delete” either during or within a configurable amount of time after the selected email message is read. Mr. Smith's request to delete the selected email message is received by voice server 230 at step 1110. In response, server 230 signals gateway 231 to access the corresponding email account, as indicated at step 1120, which is in this instance Mr. Smith's email account at Address1. At step 1130 gateway 231 causes the selected email message to be deleted. Mr. Smith may be provided with an opportunity to confirm his choice before the message is deleted. For example, voice server 230 may state, “This message will be deleted from you email account. To cancel this action press ‘1’ now.” Thus, to confirm his decision to delete the message, Mr. Smith may press ‘1’ on his telephone.

If while a message is being read, the user wishes to skip the remainder of the message and hear header information for the next message immediately, the user may say “Next.” In response, voice server 230 stops reading the current email message, and gateway 231 activates the “Read Headers” routine, causing voice server 230 to read the header information concerning the next email message. Similarly, the user may say, “Previous” to listen to the header information concerning a previous email message. In response to the user's request, voice server 230 stops reading the current message, and gateway 231 activates the “Reader Headers” routine, starting with the email message immediately prior to the current message. If the user wishes to return immediately to the operator, he/she may say “Operator.” In response, voice server 230 stops reading the email message, and the user is reconnected to the operator. If the user wishes to hear a message again after it has been read, he/she may say, “Repeat,” and in response, voice server 230 reads the message again to the user.

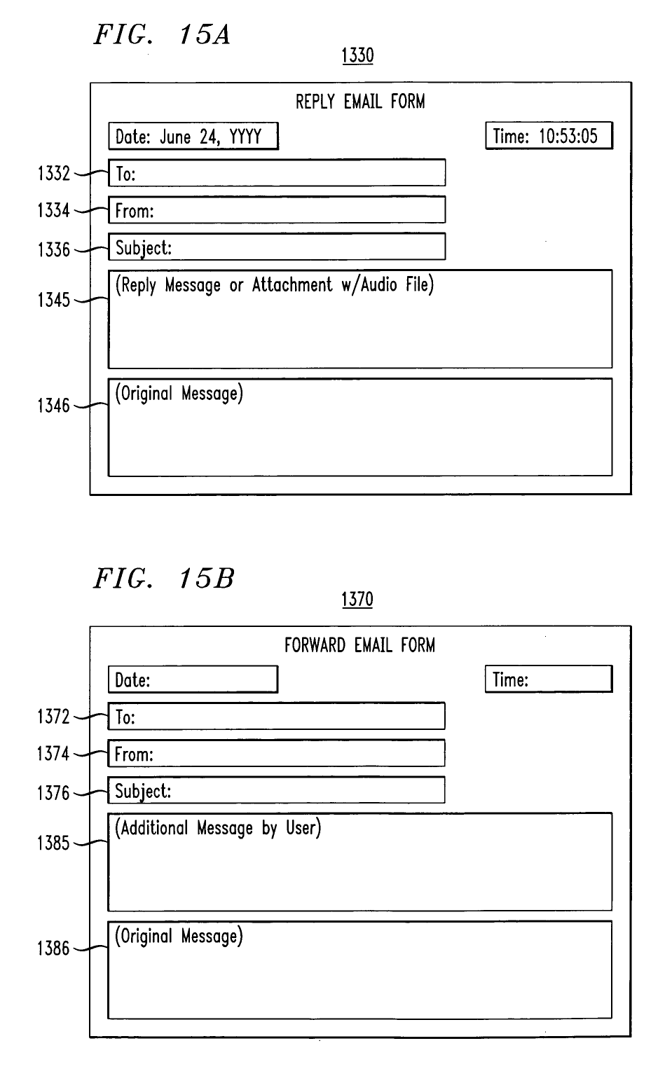

Let's suppose that after hearing the Johannes Taylor message, instead of deleting the message, Mr. Smith wishes to send a reply email message. Accordingly, he may say, “Reply,” or, alternatively, press a predetermined key on his telephone. FIG. 14 illustrates a routine for creating and sending a reply email message in response to a user's request, in accordance with an embodiment. At step 1210, the request for sending a reply message is received from Mr. Smith. At step 1220, Mr. Smith is reconnected to the operator, and at step 1230, gateway 231 presents a GUI containing a reply email form to the operator on terminal 220. FIG. 15A illustrates an example of a reply email form 1330 that may be presented on terminal 220. Form 1330 comprises fields 1332, which holds an address of the intended recipient of the reply message, field 1334, containing an address of the sender of the email (which in the case of a reply email message is the address of the user), and field 1336, containing a description of the subject of the message. Fields 1345-1346 contain the reply message and the original message, respectively.

Several fields in form 1330 are populated automatically based on the header information in the original email message. Thus, at step 1240, gateway 231 retrieves the address of the sender of the original email message (in this instance, the address of Johannes Taylor) and uses it to populate recipient address field 1332 in voice email form 1330. At step 1250, gateway 231 copies the subject line data from the original email message to subject field 1336 in form 1330. At step 1260, gateway 231 accesses Mr. Smith's email folder, retrieves Mr. Smith's default reply address from field 730 in record 710, and enters the default reply address into sender address field 1334 of form 1330. At step 1270, gateway 231 copies the text of the original message to original message field 1346 of form 1330.

At this point, Mr. Smith is connected to voice server 230 to create a voice audio file, which may be in an MP3 format. At step 1275, Mr. Smith is prompted to utter his reply message. For example, either the operator or voice server 230 may announce, “Please speak your reply message at the tone; it will be recorded as an audio file and sent as an attachment to your reply message.” At step 1280, voice server 230 records Mr. Smith's spoken reply message and, at step 1285, converts it into an audio file. Voice server 230 provides the audio file to gateway 231. At step 1290, gateway 231 attaches the audio file to the reply message, e.g., in field 1345 of form 1330, and at step 1295, sends the reply message to the recipient's address. In an alternative embodiment, the spoken reply message recorded at step 1280 may be converted into a text message by means of a conventional voice-to-text conversion application. In this case, the converted text message may be inserted into field 1345 on form 1330; the reply message is then sent to the recipient as a text message.

Suppose instead that after hearing the Johannes Taylor message read, Mr. Smith wishes to forward the email message to a third party. Accordingly, Mr. Smith may say, “Forward,” or, alternatively, press a predetermined key on his telephone. As a result, Mr. Smith is reconnected to the operator, and gateway 231 presents a GUI containing a forward email form on terminal 220. FIG. 15B illustrates an example of a forward email form 1370 that may be presented. Form 1370 comprises field 1372 for entry of an address of the intended recipient of the forward email message, field 1374 for entry of an address of the sender of the message (which in the case of a forward email message is the address of the user), and field 1376 for entry of a description of the subject of the message. Field 1385 is used for entry of any additional message that the user wishes to add to the original message. Field 1386 contains the original message.

The operator may then ask Mr. Smith to specify a recipient's address, and once an address is obtained, enter it into field 1372 on form 1370. Several fields in form 1370 are populated automatically based on the header information data in the original email message. Thus, for example, gateway 231 copies the subject line data from the original email message to subject field 1376 in form 1370. Gateway 231 also copies the text of the original message to original message field 1386 of form 1370. Gateway 231 may also access Mr. Smith's email folder, retrieve Mr. Smith's default reply address from field 730 of record 710, and insert the default reply address into sender address field 1374 of form 1370. Alternatively, the operator may prompt Mr. Smith to specify a sender address, obtain an address from Mr. Smith verbally, and enter the address into field 1374.

The operator may then ask Mr. Smith if he wishes to add his own message to the forward email message. If he answers in the affirmative, Mr. Smith may be connected to voice server 230 to create a voice audio file. Voice server 230 records Mr. Smith's spoken message and converts it into an audio file. Voice server 230 provides the audio file to gateway 231. Gateway 231 attaches the audio file to the forward email message, e.g., in field 1385 of form 1370, and sends the forward message to the recipient's address. In an alternative embodiment, the spoken message may be converted into a text message, e.g., by a voice-to-text conversion application. In that case, the converted text message may be inserted into field 1385 on form 1370; the forward email message is then sent to the recipient as a text message.

If a user's default reply address (stored in record 710 shown in FIG. 5) is the address of one of the email accounts specified in the user's email folder, the user may be notified if a delivery error is received in that account in connection with a reply message (or a forwarded message). Suppose, for example, that Mr. Smith specifies his default reply address to be Address1. After Mr. Smith generates a reply message to Johannes Taylor and causes it to be sent in the manner described above, gateway 231 monitors Mr. Smith's email account at Address1 for the duration of a predetermined period to detect whether or not a delivery error message is received at that email account. Gateway 231 may record in a designated memory address the time at which Mr. Smith's reply message is sent and/or the recipient's address. Subsequently, for the duration of a predetermined period, gateway 231 monitors Mr. Smith's email account at Address1 from time to time, e.g., periodically.

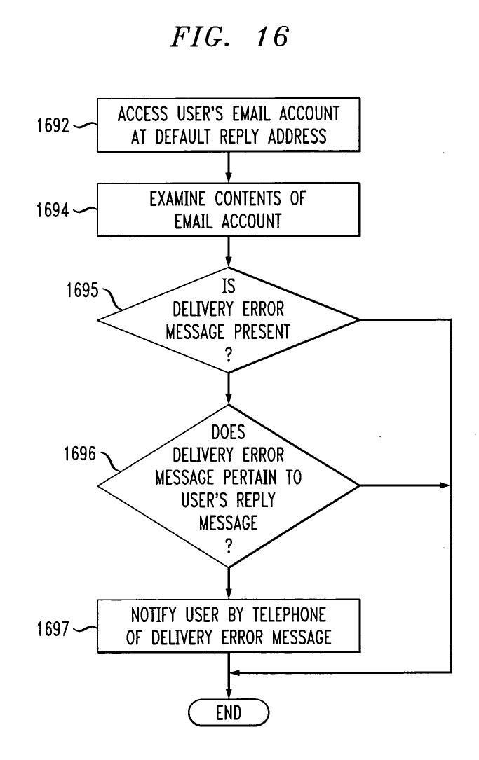

FIG. 16 is a flowchart depicting a routine for detecting a delivery error and notifying a user thereof. In this example, gateway 231 examines Mr. Smith's email account at Address1 once per fifteen minutes for twenty-four hours, which examination involves accessing Mr. Smith's account at Address1, as indicated at step 1692. At step 1694, gateway 231 examines the contents of Mr. Smith's email account at Address1 to determine whether or not a delivery error message is present. In accordance with block 1695, if a delivery error message is-found in the account, gateway 231 next determines whether or not the delivery error pertains to Mr. Smith's reply message, i.e., to Johannes Taylor. Gateway 231 may, for example, retrieve the timestamp information and recipient address information stored in the designated memory address described above, and use this information to identify the delivery error message. In accordance with block 1696, if the delivery error message pertains to Mr. Smith's reply message, the routine proceeds to step 1697 and Mr. Smith is notified at his alert address (stored in his email folder—e.g. in record 710 of FIG. 5). If Mr. Smith's alert address is a telephone number, for example, Mr. Smith gateway 231 may cause voice server 230 to place a call to Mr. Smith's alert telephone number and play an automated notification message. If no delivery error message is found, the routine comes to an end. Gateway 231 repeats the routine illustrated in FIG. 16 once every fifteen minutes for twenty-four hour period after Mr. Smith's reply message is sent, or until a delivery error message is detected.

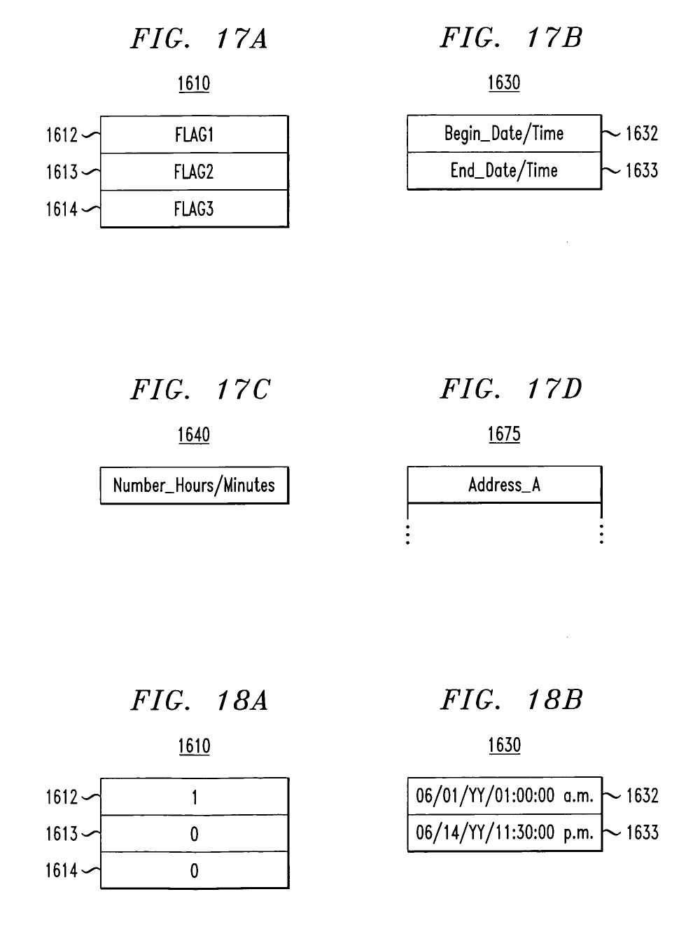

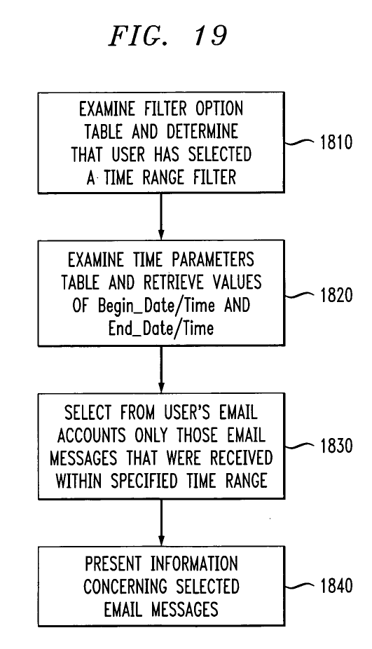

In another embodiment, a user may specify one or more parameters that may be used to control which email messages are presented to him or her. For example, a user may be afforded the option of selecting among several different types of “message filters.” To enable this functionality, a set of tables such as those shown in FIGS. 17A-D may be stored in the user's email folder. Filter option table 1610 in FIG. 17A comprises three fields 1612-1614 and indicates which message filter(s), if any, the user has selected. Each of fields 1612-1614 contains a binary flag value. If each of fields 1612-1614 contains a flag value “0,” the user has-not selected a filter, and new email messages are presented to the user in the manner described above. However, if field 1612 contains a flag value “1,” a “time range filter” is applied to the email messages in the user's email accounts, i.e., only those email messages that were received between a first specified date/time and a second specified date/time are presented to the user. If field 1613 contains a flag value “1,” a “sliding time window filter” is applied, i.e., only those email messages that were received within a specified time period before the date and time at which the user call is received, are presented to the user. If field 1614 contains a flag value “1,” an “address filter” is applied to the user's email messages, i.e., only email messages that were received from any one of predetermined email addresses are presented to the user. A user may be prompted either upon registration or at a later time to specify a message filter.

Suppose that Mr. Smith tells the operator that he wants to hear only messages that were sent between Jun. 1, YYYY 01:00:00 a.m. and Jun. 14, YYYY 11:30:00 p.m. Accordingly, the operator sets up a time range filter by entering these dates and times into appropriate fields on terminal 220, and, in response, gateway 231 inserts these sets of dates and times into time parameters table 1630 in FIG. 17B. In this instance, the parameter Begin_Date/Time in field 1632 assumes a value representing Jun. 1, YYYY/01:00:00 a.m., and the parameter End_Date/Time in field 1633 assumes a value representing Jun. 14, YYYY/11:30:00 p.m. Gateway 231 also assigns a flag value “1” to field 1612 in filter option table 1610, indicating that the time range filter is active. FIGS. 18A and B respectively illustrate tables 1610 and 1630 resulting from Mr. Smith's specifying the parameters Begin_Date/Time and End_Date/Time as described above.

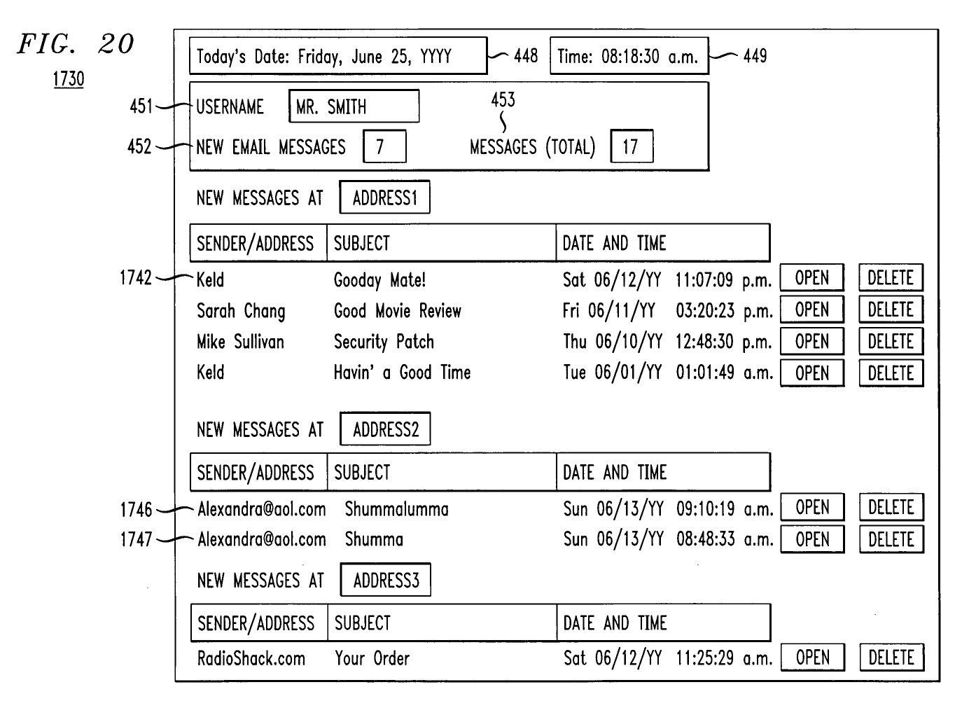

FIG. 19 illustrates a routine for providing information concerning email messages in a user's email accounts subject to a time range filter. At step 1810, gateway 231 examines filter option table 1610 in FIG. 18A and determines that, because field 1612 contains a flag value “1,” Mr. Smith has selected a time range filter. Accordingly, at step 1820, gateway 231 examines time parameters table 1630 and retrieves the values of Begin_Date/Time and End_Date/Time, which in this instance are Jun. 1, YYYY/01:00:00 a.m. and Jun. 14, YYYY/11:30:00 p.m., respectively. After obtaining these values, gateway 231 at step 1830 selects from Mr. Smith's email accounts only those email messages that were received within the specified time range. Referring back to FIG. 8A, for example, gateway 231 selects from Mr. Smith's inbox associated with Address1 the email message from Keld at line 794, which was sent on Saturday, Jun. 12, YYYY, and thus satisfies the specified time range. In this example, gateway 231 also selects the email messages from Sarah Chang per entry 795, the message from Mike Sullivan per entry 796 and the message from Keld per entry 797. Gateway 231 also examines Mr. Smith's email accounts at Address2 (FIG. 8B) and Address3 (FIG. 8C), and selects all email messages that satisfy the specified time range. At step 1840, gateway 231 presents information concerning the selected email messages to the operator in a GUT on terminal 220. FIG. 20 illustrates one such GUT denoted 1730. GUT 1730 displays only those email messages in Mr. Smith's email accounts that were received between (in this case inclusive of) Jun. 1, YYYY/01:00:00 a.m. and Jun. 14, YYYY/11:30:00 p.m. For example, the email from Keld in entry 794 in FIG. 8A is listed as entry 1742 in GUT 1730. At this point, the operator may read the header information in GUT 1730 to Mr. Smith; alternatively, gateway 231 may initiate a “Read Headers” routine and cause voice server 230 to read the header information automatically.

Suppose that Mr. Smith instead asks the operator to set up a sliding time window filter so that whenever he calls to receive an update concerning his email accounts, only those email messages that were received during the past two days are reported. In this case, referring to FIG. 17C, the length of the time window specified by Mr. Smith is stored in table 1640, which comprises a Number_Hours/Minutes field. Accordingly, the operator may enter “48:00” in a predetermined field on terminal 220, and gateway 231 in response may insert the value “48:00” into table 1640. Consequently, the Number_Hours/Minutes assumes the value “48:00.” Gateway 231 also assigns a flag value “1” to field 1613 of filter option table 1610, indicating that the sliding time window filter is active.

Subsequently, if Mr. Smith asks the operator for the status of his email accounts, gateway 231 examines filter option table 1610 and determines that, because field 1613 contains a flag value “1,” Mr. Smith has selected a sliding time window filter. Accordingly, gateway 231 examines table 1640 and finds that the Number_Hours/Minutes field therein contains the value “48:00.” Accordingly, gateway 231 may generate on terminal 220 a GUI presenting information concerning only those email messages that were received in the last two days. Alternatively, gateway 231 may initiate a “Read Headers” routine and cause voice server 230 to read the header information concerning such email messages to the user.

Suppose that Mr. Smith asks the operator to set up an address filter so that only email messages received from one or more selected email addresses are presented to him when he checks email messages in his accounts. For example, Mr. Smith may ask that he only be presented email messages that are received from Johannes Taylor. Mr. Smith provides the email address of Johannes Taylor, say, “JT_address,” and the operator enters “JT_address” into an appropriate field on terminal 220. In response, gateway 231 enters “JT_address” into table 1675, which in this example comprises only one field. It should be noted that a user may provide multiple addresses, and thus table 1675 may comprise multiple fields each holding a different address. Gateway 231 also assigns a flag value “1” to field 1614 of filter option table 1610.

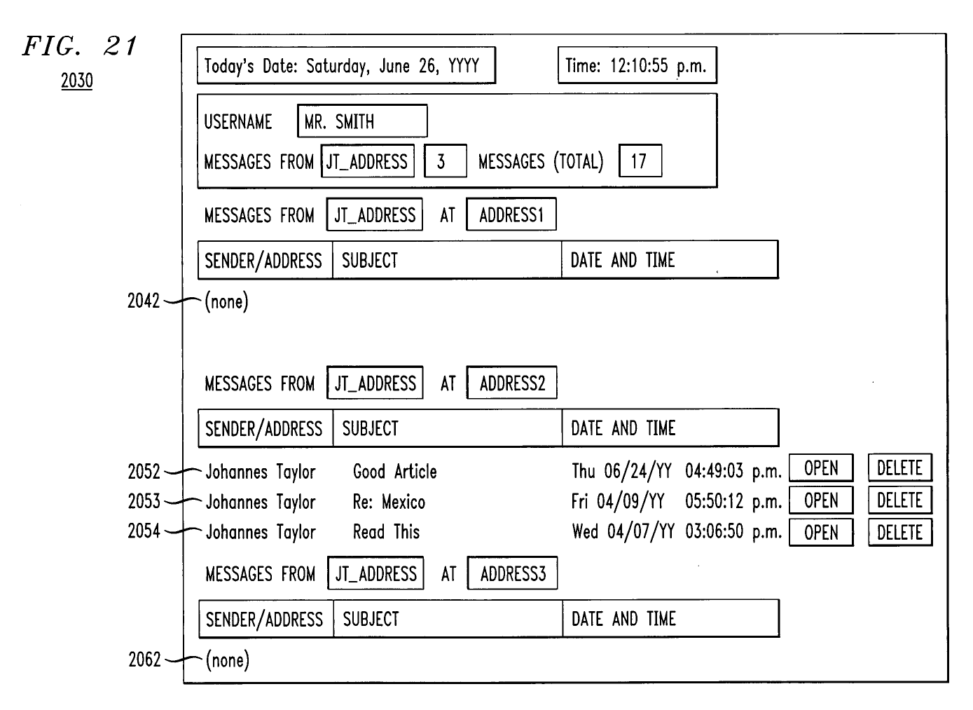

Subsequently, if Mr. Smith asks the operator for the status of his email accounts, gateway 231 examines filter option table 1610 and determines that, because field 1614 contains a flag value “1,” Mr. Smith has selected an address filter. Accordingly, gateway 231 examines table 1675 and retrieves the address “JT_address.” Gateway 231 then retrieves from Mr. Smith's three email accounts any emails that were received from “JT_address.” Since “JT_address” is the email address of Johannes Taylor, gateway 231 may generate on the operator terminal 220 a GUI displaying only email messages received from Johannes Taylor. For example, gateway 231 may generate GUI 2030 as shown in FIG. 21, which lists the email messages from Johannes Taylor that were received in Mr. Smith's three email accounts. Referring to GUI 2030, entry 2042 indicates that no email messages from Johannes Taylor are present in the email account at Address1. Three email messages from Johannes Taylor are shown at entries 2052-2054 in the email account at Address2; and no email messages from Johannes Taylor are present in the account at Address3 (line 2062).

It should be noted that message filters are not necessarily mutually exclusive. For example, Mr. Smith may choose to select both a time range filter and an address filter, in which case gateway 231 may cause only email messages sent from a selected group of addresses between a first specified date/time and a second specified date/time to be presented to Mr. Smith. Other possibilities may also be possible. It should also be noted that although only three message filter options are described in the illustrative example, any number of filter options may be made available to users of the information assistance service.

It should also be noted that an operator may, at the request of a user, override any pre-existing message filters and cause gateway 231 to select and present email messages satisfying parameters specified during the user's call. For example, suppose that Mr. Smith has previously established a sliding time window filter to show only those email messages that were sent during the past 48 hours. Nevertheless, Mr. Smith may call the information assistance service and ask to hear header information for all email messages sent in the past six months. In response, the operator may override Mr. Smith's existing parameter settings and cause gateway 231 to select all email messages from Mr. Smith's accounts that were sent during the past six months. Gateway 231 accordingly presents a GUI to the operator dispaying the requested email messages, and the operator may report the results to Mr. Smith.

In yet another embodiment, whenever new email messages arrive in a user's email accounts, the user is notified at his/her alert address. Gateway 231 may accordingly access the user's email accounts automatically and periodically to verify the status thereof. Whenever gateway 231 detects that a new email has arrived in one of the user's email accounts, gateway 231 causes an “alert” message, in the form of, e.g., a text message, to be sent to the alert address specified in the user's email folder. If the alert address comprises a telephone number, gateway 231 may cause voice server 230 to place a call to the alert telephone number and play an automated notification message. Other alert addresses may include, but not limited to, a facsimile number, and SMS, WAP, URL, IP and postal addresses.

Alternatively, a user may request email notification based on other conditions, e.g., if a received email indicates a certain action required of the user or response due date, or if a received email is marked “important.” In addition, a user may request notification whenever an email having a specified keyword in its subject line and/or in its body arrives in one of the user's email accounts. Whenever gateway 231 detects that an email satisfying the specified condition has arrived in one of the user's email accounts, gateway 231 causes an alert message to be sent to the alert address specified in the user's email folder. Similarly, a user may request notification if an email arrives during a specified period during the day, e.g., between 2:00 PM and 4:00 PM, if an email with an attachment is received, etc.

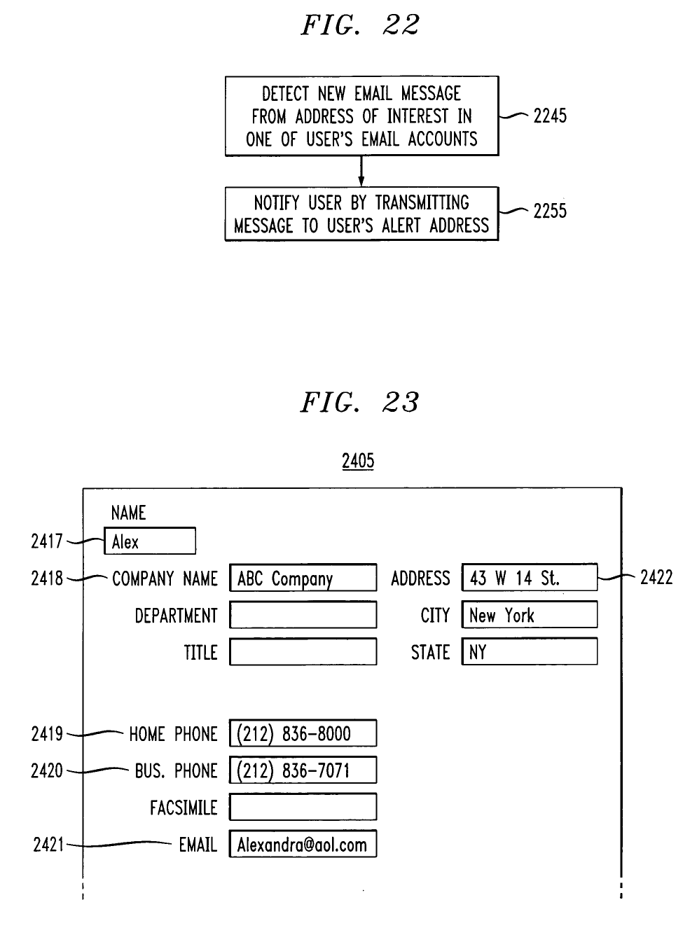

The user may additionally request that he/she be notified whenever an email message is received from a specified individual or a particular address of interest. For example, as mentioned above, the user may specify in his/her email folder an address of interest, e.g., an email address associated with a particular individual. As described above, gateway 231 accesses the user's email accounts automatically and periodically to verify the status thereof Referring to FIG. 22, whenever gateway 231 detects that a new email has arrived from the address of interest (step 2245), gateway 231 notifies the user thereof (step 2255), e.g., by causing a text message to be sent to the alert address specified in the user's email folder. If the alert address comprises a telephone number, gateway 231 may cause voice server 230 to place a call to the alert telephone number and play an automated notification message. As described above, a user's alert address may encompass other forms of communications, as well. For example, the alert address may comprise a facsimile number, a pager number, etc.

The inventive information assistance provider may charge a fee to provide the notification service described above. For example, when a new email message from a user's specified address of interest is detected, gateway 231 may cause voice server 230 to call the user and announce, “A priority message has arrived. Please press one if you would like to accept the charges and hear the message.” If the user presses the appropriate key (“1” in this example), gateway 231 causes voice server 230 to read the email message to the user; gateway 231 also records the transaction so that the user is subsequently billed appropriately. Gateway 231 may forward the billing information to a billing platform (not shown) to charge the transaction to the user's account.

Similarly, if the user is a registered user of the information assistance service provider's “concierge” services or other, similar, services, the information assistance service provider may generate email alert messages (or alert messages transmitted by telephone, facsimile, text message, etc.) for the user in order to notify the user of products and services that may be of interest to him/her. The concierge services encompass a wide variety of services that are provided via telephone to satisfy a user's needs. Typically, a user places a call to an operator, who then listens to the user's request. The user may request a restaurant reservation, a flight reservation, a reservation or purchase of concert tickets, etc. Examples of concierge services are described in U.S. Pat. No. 6,775,371, issued Aug. 10, 2004 to N. Elsey et al., hereby incorporated by reference. The operator may refer to a user profile maintained for the user and note any preferences, such as the user's preference for outdoor dining. The operator then suggests a service, an event or restaurant in accordance with the user's desires and preferences. Should the suggestion be satisfactory, the operator will make the necessary reservations and inform the user of the reservation details.

In one embodiment, alert messages may be generated and transmitted based on information in a user's personal profile. Suppose, for example, that a particular user specifies during registration that he/she likes music by the musical group Green Day. This information is stored in the user's profile as described above. The user may also be asked if he/she would like to receive alert messages whenever a Green Day concert is scheduled to take place in the user's home city. Assuming the user chooses to receive this service, the inventive information assistance provider may direct its concierge service to inform gateway 231 whenever it determines that a Green Day concert is scheduled to take place in the user's home city. When such an event occurs, gateway 231 notifies the user thereof by causing, e.g., a text message, to be transmitted to the user's alert address specified in the user's email folder. If the user's alert address comprises a telephone number, gateway 231 may cause voice server 230 to place a call to the alert telephone number and play an automated message.

The user may be charged a fee to receive such an alert message. For example, if a scheduled Green Day concert is noted by the concierge service, gateway 231 may cause voice server 230 to call the user and announce to the user, “There is a message containing priority information generated based on your personal profile. Please press one if you would like to accept the charges and hear the message.” If the user presses the appropriate key (“1” in this example), gateway 231 causes voice server 230 to announce the Green Day concert, and the scheduled date and time thereof A concierge server (not shown) may also be activated and offer to purchase concert tickets for the user. Gateway 231 records the transaction so that the user is subsequently billed appropriately. Gateway 231 may forward the billing information to a billing platform (not shown) to charge the transaction to the user's account.

When information pertaining to a user's email accounts is read to the user, e.g., during the Read Headers routine, a user may sometimes not receive enough information to determine the identity of the sender of a particular email. Suppose, for example (referring back to FIG. 20) that, unknown to Mr. Smith, the two email messages indicated in lines 1746 and 1747, which are shown with the sender address “Alexandra@aol.com,” were sent by an old friend known to Mr. Smith as “Alex.” Because Mr. Smith does not know his friend's email address, when the operator reads “Alexandra@aol.com,” Mr. Smith may not realize that these messages came from Alex. To provide additional information to users, in an alternative embodiment the inventive information assistance provider uses a stored name of the sender of an email message when announcing header information to the user. A sender's name may be retrieved, for example, from a contacts folder maintained by the inventive information assistance provider for the user.

A user's contacts folder (also known as a private directory) stores names, telephone numbers, and similar information pertaining to the user's friends, colleagues. etc. An example of a contacts folder is disclosed in the '230 Application mentioned above. FIG. 23 illustrates a hypothetical record that may be maintained for Mr. Smith. Record 2405 includes information pertaining to Mr. Smith's friend Alex. Name field 2417 stores the name of the respective individual (in this instance, “Alex”). The record includes fields for a variety of additional information pertaining to Alex. For example, fields 2418, 2419, 2420, 2421, and 2422 hold information pertaining to Alex's company name, home phone, business phone, email address, and address, respectively.

Before presenting header information for the two selected email messages received from “Alexandra@aol.com” to the operator in a GUI, gateway 231 additionally accesses Mr.

Smith's contacts folder. Gateway 231 may, for example, transmit a request to server 28 to retrieve Mr. Smith's contacts folder. In response, server 28 uses identifying information such as the ANI to retrieve Mr. Smith's contacts folder from database 20, and provides a copy thereof to gateway 231.

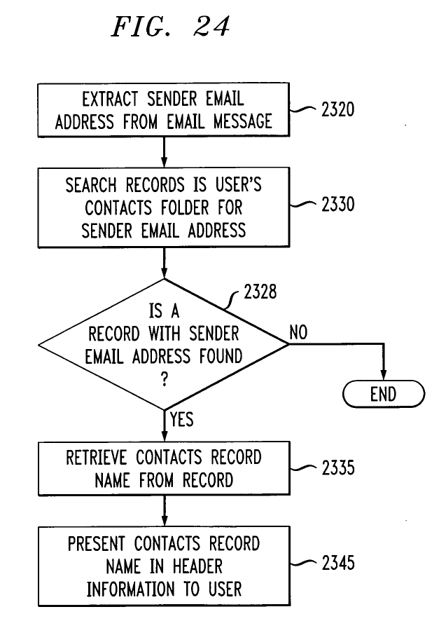

Gateway 231 examines Mr. Smith's contacts folder and uses name data stored therein to present the header information to him. Referring to FIG. 24, at step 2320 gateway 231 examines one of the selected email messages received from “Alexandra@aol.coml.” and extracts the sender's email address therefrom. In this instance, the sender's email address is “Alexandra@aol.com.”

At step 2330, gateway 231 searches the records in Mr. Smith's contacts folder to determine whether the email address “Alexandra@aol.com” is stored therein. Gateway 231 may perform multiple searches within the contacts folder. For example, referring record 2405, gateway 231 may search both “Email” field 2421 and “Address” field 2422 within the record.

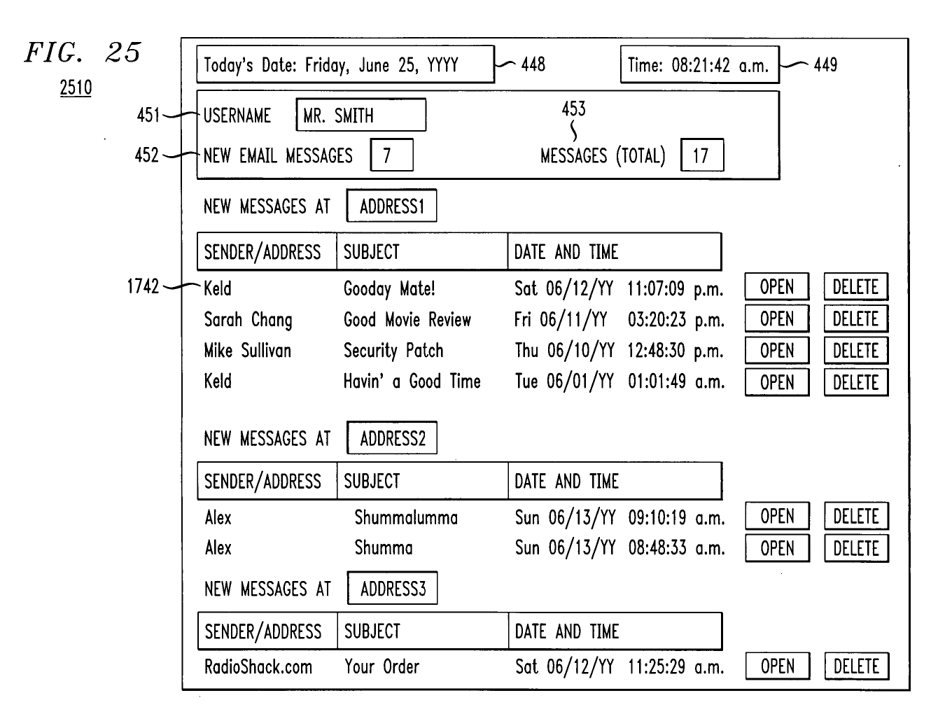

In the illustrative example, record 2405 includes the email address “Alexandra@aol.com” in Email field 2421. Thus, in accordance with block 2328, the routine proceeds to step 2335 and gateway 231 retrieves the “Name” data stored in field 2417, which in this instance is “Alex.” At step 2345, gateway 231 presents the Name data, “Alex,” in place of “Alexandra@aol.com” in the header information for the respective email message. Steps 2320 through 2345 may be repeated for each selected email message. FIG. 25 shows GUT 2510 in which the name “Alex” is presented in the header information for both of the email messages received from “Alexandra@aol.com.”

At this point, the operator may read the header information in GUI 2510 to Mr. Smith; alternatively, gateway 231 may initiate a “Read Headers” routine and cause voice server 230 to read the header information automatically, based on the information in GUT 2510.

The foregoing merely illustrates the principles of the invention. It will thus be appreciated that those skilled in the art will be able to devise numerous other arrangements that embody the principles of the invention and are thus within the spirit and scope of the invention, which is defined by the claims below.

Finally, information/call center 200 and its components are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing an information assistance service, comprising:
storing first data concerning access to one or more email accounts associated with a user;
storing a contacts folder associated with the user, the contacts folder containing first information concerning one or more contacts, the first information including names by which the user refers to the respective contacts;
receiving a communication from the user through a first communications connection;
retrieving the first data;
based on the first data, accessing the one or more email accounts over a second communications connection;
obtaining second data concerning a sender of a selected email message received in one of the email accounts;
identifying a name of a contact in the contacts folder based on the second data; and
providing, to the user, second information concerning the selected email message, the second information including the name of the contact.

2. The method of claim 1, wherein the second data includes an email address from which the selected email message originates.

3. The method of claim 2, wherein the first information also includes the email address, which is associated with the name of the contact in the contacts folder.

4. The method of claim 1, wherein the second information comprises header information concerning the at least one email message.

5. The method of claim 1, wherein the first communications connection includes a telephonic connection.

6. The method of claim 1, wherein the second information is provided to the user via telephone.

7. A method for providing an information assistance service, comprising:
receiving a communication from a user through a first communications connection;
accessing at least one email account associated with the user over a second communications connection based on data received during the communication;
providing, to the user, information concerning at least one email in the at least one email account;
at the user's request, generating a reply email in response to the at least one email;
sending the reply email to a recipient from a selected email account associated with the user;
detecting a message concerning delivery of the reply email in the selected email account; and
notifying the user of the message.

8. The method of claim 7 wherein the at least one email account and the selected email account are the same.

9. The method of claim 7 wherein the message indicates non-delivery of the reply email.

10. The method of claim 7 wherein the user is notified of the message via telephone.

11. The method of claim 7 wherein the user is notified of the message via email.

12. The method of claim 7 wherein the user is notified of the message via SMS.

13. The method of claim 7 wherein the communication includes a telephonic communication.

14. The method of claim 13 wherein the data includes an automatic number identification (ANI).

15. A method for providing an information assistance service, comprising:
storing data concerning access to one or more email accounts associated with a user;
accessing the one or more email accounts using the data;
determining that an email message having attributes selected by the user is received in the one or more email accounts; and
sending a communication concerning the email message to an address specified by the user.

16. The method of claim 15 wherein the communication includes an option of accepting charges for receiving information concerning the email message.

17. The method of claim 16 wherein providing the information to the user after the user opts to accept the charges.

18. The method of claim 15 wherein the address includes a telephone number.

19. The method of claim 15 wherein the address includes a facsimile number.

20. The method of claim 15 wherein the address includes an SMS address.

21. The method of claim 15 wherein the address includes an IP address.

22. A method for providing an information assistance service, comprising:
receiving, from a user, attributes of an event of interest;
identifying the event of interest based on the attributes;
determining an occurrence of the event of interest;
initiating a communication to the user after the occurrence of the event of interest is determined, the communication including an option of accepting charges for receiving information about the event of interest; and
providing information about the event of interest after the user opts to accept the charges.

23. The method of claim 22 wherein the event of interest includes a musical event.

24. The method of claim 23 wherein the attributes includes information concerning one or more performers in the musical event.

25. The method of claim 22 wherein the communication includes a telephonic communication.

26. The method of claim 22 wherein the communication includes an email communication.

27. The method of claim 22 wherein the communication includes an SMS communication.

28. The method of claim 22 wherein the attributes are stored in a profile associated with the user.
